(19) United States
(12) Patent Application Publication
(10) Pub. No.: US 2003/0235757 A1
(43) Pub. Date: Dec. 25, 2003

(54) Sealing method for battery and battery sealed thereby

(75) Inventor: Norihiko Hirata, Kanagawa (JP)

Correspondence Address: McDERMOTT, WILL & EMERY, 600 13th Street, N.W., Washington, DC, 20005-3096, US

(73) Assignee: Nissan Motor Co., Ltd.

(21) Appl. No.: 10/465,587

(22) Filed: Jun. 20, 2003

(30) Foreign Application Priority Data
Jun. 25, 2002 (JP) 2002-184532

(51) Int. Cl. H01M 2/08; H01M 10/04

(52) U.S. Cl. 429/185; 29/623.2; 29/623.4

(57) ABSTRACT

A sealing method for a battery including a power generating element disposed between two laminate films whose peripheral sections are joined to form a joining section. Anode and cathode tabs connected to the anode and cathode plates of the power generating element are drawn out of the container through the joining section of the two laminate films. The sealing method comprises (a) providing two resin sheets respectively around two sites where the anode and cathode tabs are respectively located, to be positioned between the peripheral sections of the two laminate sheets; (b) covering opposite side end sections of each of the anode and cathode tabs with each of the two resin sheets; and (c) thermally welding the two resin sheets in a condition where each resin sheet is put between the peripheral sections of the two laminate films.

### BACKGROUND OF THE INVENTION

This invention relates to improvements in a sealing method for a battery including an outer casing for accommodating a power generating element, formed of laminate films whose peripheral sections are joined by thermal welding, and anode and cathode tabs which are respectively connected to anode and cathode plates of the power generating element and drawn out of the outer casing through a joining section of the laminate films, each laminate film including a metal layer and a synthetic resin layer, and to a battery which is sealed by the sealing method.

In recent years, air pollution with exhaust gas of automotive vehicles have become a worldwide problem, upon which attention is made on electric vehicles driven by an electric power source and hybrid cars driven by the combination of an engine and a motor. In this regard, an industrially important position has been occupied by development for high power output batteries having a high energy density and a high power output density. Examples of such high power output batteries are lithium ion batteries. As the lithium ion batteries, there are ones of the cylindrical type wherein anode and cathode plates are wound upon interposing a separator between the anode and cathode plates, and ones of the laminate type wherein flat anode and cathode plates are laminated upon interposing a separator between the anode and cathode plates.

In the latter laminate type batteries, a flat power generating element is put between laminate films in such a manner that the opposite surfaces of the power generating element are respectively in contact with the laminate films. The peripheral sections of the laminate films are joined with each other under thermal welding thereby forming a sealed container for the power generating element. Electrolysis solution is sealed together with the power generating element within the sealed container. An example of such laminate type batteries is disclosed in Japanese Patent Provisional Publication No. 2000-77044. In the laminate type battery in this Publication, an electrode tab is connected to an anode plate while another electrode tab is connected to a cathode tab. The electrode tabs are drawn out of the container through the joined peripheral sections (forming a joining section) of the laminate films, in which clearances may be formed between the opposite side end sections of each electrode tab having a rectangular cross-section and the joining section of the laminate films, thereby raising such a problem that the electrolysis solution leaks out of the container through the clearances. In this regard, the Publication proposes to prevent formation of the clearances by forming tapering the cross-sectional shape of the opposite side end sections of each electrode tab.

### SUMMARY OF THE INVENTION

However, in order to forming tapering the cross-sectional shape of the opposite end sections of each electrode tab, a high machining or working precision is required since the electrode tab itself is a small part. Accordingly, the formability of the electrode tab will be degraded, and therefore additional machining processes for obtaining the high machining precision are required thereby degrading the production efficiency of the batteries while unavoidably raising the production cost of the batteries.

It is, therefore, an object of the present invention to provide an improved sealing method for a battery and an improved battery sealed thereby, which can effectively overcome drawbacks encountered in the conventional sealing methods and conventional batteries.

Another object of the present invention is to provide an improved sealing method for a battery and an improved battery sealed thereby, which can effectively prevent clearances from being formed between an electrode tab and a joining section of laminate films forming a sealed container for a power generating element, without applying complicated machining or working to the electrode tab itself.

An aspect of the present invention resides in a sealing method for a battery which includes a power generating element including an anode plate, a cathode plate and a separator disposed between the anode plate and the cathode plate, first and second laminate films between which the power generating element is disposed, each of the first and second laminate films including a metal layer and a synthetic resin layer, the first and second laminate films having respectively first and second peripheral sections which are to be joined with each other by thermal welding so as to form a peripheral joining section so that the first and second laminate films serve as a container inside which the power generating element is sealingly disposed, and anode and cathode tabs which are respectively connected to the anode and cathode plates, the anode and cathode tabs being drawn out of the container through the joining section of the laminate films. The sealing method comprises (a) providing first and second resin sheets respectively around first and second sites where the anode and cathode tabs are respectively located, to be positioned between the first and second peripheral sections of the first and second laminate sheets; (b) covering opposite side end sections of the anode tab with the first resin sheet and covering opposite side end sections of the cathode tab with the second resin sheet; and (c) thermally welding the first and second resin sheets in a condition where each resin sheet is put between the first and second peripheral sections of the first and second laminate films after covering the opposite side end sections of the anode and cathode tab respectively with the first and second resin sheets.

Another aspect of the present invention resides in a battery comprising a power generating element including an anode plate, a cathode plate, and a separator disposed between the anode plate and the cathode plate. First and second laminate films are provided so that the power generating element is disposed therebetween. Each of the first and second laminate films includes a metal layer and a synthetic resin layer. The first and second laminate films have respectively first and second peripheral sections which are to be joined with each other by thermal welding so as to form a peripheral joining section so that the first and second laminate films serve as a container inside which the power generating element is sealingly disposed. Anode and cathode tabs are respectively connected to the anode and cathode plates. The anode and cathode tabs are drawn out of the container through the joining section of the laminate films. Additionally, first and second resin sheets are disposed respectively around first and second sides where the anode and cathode tabs are respectively located, to be positioned between the first and second peripheral sections of the first and second laminate sheets. The first resin sheet covers opposite side end sections of the anode tab, and the second resin sheet covers opposite side end sections of the cathode tab. The first and second resin sheets are welded respectively to the anode and cathode tabs under heating.

### BRIEF DESCRIPTION OF THE DRAWINGS

In the drawings, like reference numerals designate like parts and elements throughout all figures, in which:

FIG. 1 is a plan view of a first embodiment of a battery according to the present invention;

FIG. 2 is a fragmentary sectional view taken in the direction of arrows substantially along the line A-A of FIG. 1;

FIG. 3 is an enlarged sectional view taken in the direction of arrows substantially along the line C-C of FIG. 1;

FIG. 4 is a cross-sectional illustration showing a cross-sectional layer structure in a section D in FIG. 1;

FIG. 5 is a cross-sectional illustration showing a cross-sectional layer structure in a section F in FIG. 1;

FIG. 6A is a plan view of a structure in which an anode tab (a cathode tab) is covered with a synthetic resin sheet;

FIG. 6B is a cross-sectional view of the structure of FIG. 6A, taken in the direction of arrows substantially along the line E-E of FIG. 6A;

FIG. 7 is an enlarged fragmentary sectional view around a side end section of the anode tab (the cathode tab); and

FIG. 8 is an enlarged sectional view of an essential part of a second embodiment of the battery according to the present invention, similar to FIG. 6B, showing a structure in which a synthetic resin sheet is wound around the anode tab (the cathode tab).

### DETAILED DESCRIPTION OF THE INVENTION

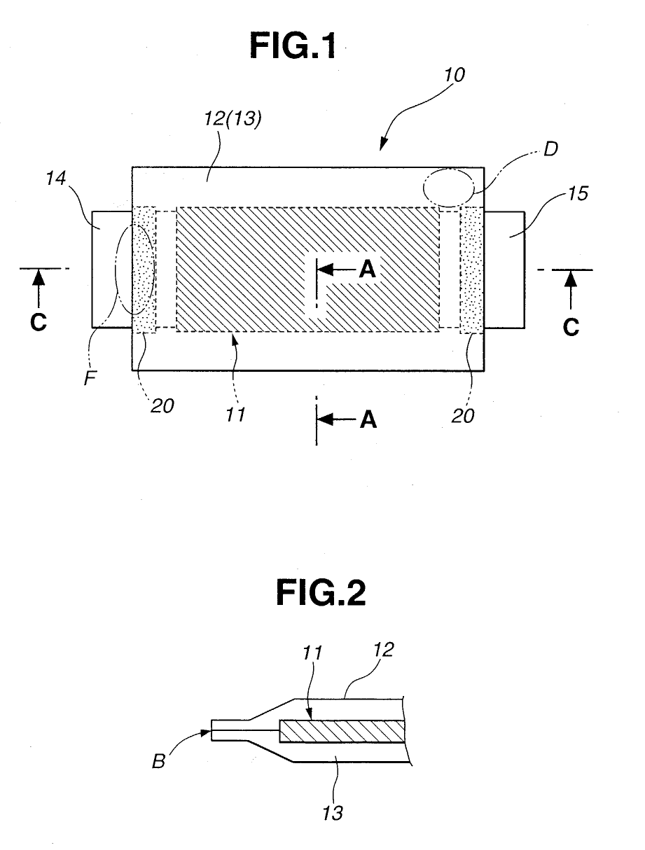

Referring now to FIGS. 1 to 7, more specifically to FIG. 1, of the drawings, a first embodiment of a battery according to the present invention is illustrated by the reference numeral 10. Battery 10 comprises a flat electrode laminate 11 serving as a power generating element. Electrode laminate 11 is disposed between two laminate films 12, 13 in such a manner that the opposite surfaces (or upper and lower surfaces) of electrode laminate 11 are covered respectively with laminate films 12, 13. As shown in FIG. 2 which is a fragmentary sectional view taken in the direction of the arrows substantially along the line A-A of FIG. 1, the respective peripheral sections of laminate films 12, 13 are joined with each other by thermal welding to form a joining section B, thus providing a sealed container or outer casing for storing power generating element 11. In this sealed container constituted of laminate films 12, 13, an electrolysis solution is disposed together with electrode laminate 11 in a sealed condition. While laminate films 12, 13 are shown thick in FIG. 2 for the purpose of clearness of illustration, laminate films 12, 13 are formed thin in practice.

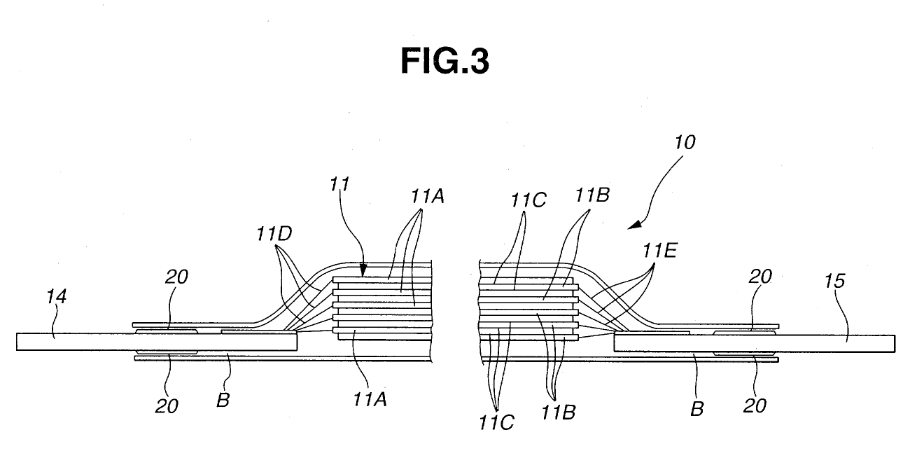

As illustrated in FIG. 3 which is an enlarged fragmentary sectional view taken in the direction of the arrows substantially along the line C-C of FIG. 1, a plurality of anode plates 11A and a plurality of cathode plates 11B are alternately laminated in which a separator 11C is interposed between each anode plate 11A and each cathode plate 11B. Each anode plate 11A is connected through an anode lead 11D with an anode (electrode) tab 14. Each cathode plate 11B is connected through a cathode lead 11E with a cathode (electrode) tab 15. These anode and cathode tabs 14, 15 are drawn out of the sealed container of laminate films 12, 13 through the joining section B. The above-mentioned anode tab 14 and cathode tab 15 are formed of foil of metal such as Al, Cu, Ni, Fe and the like.

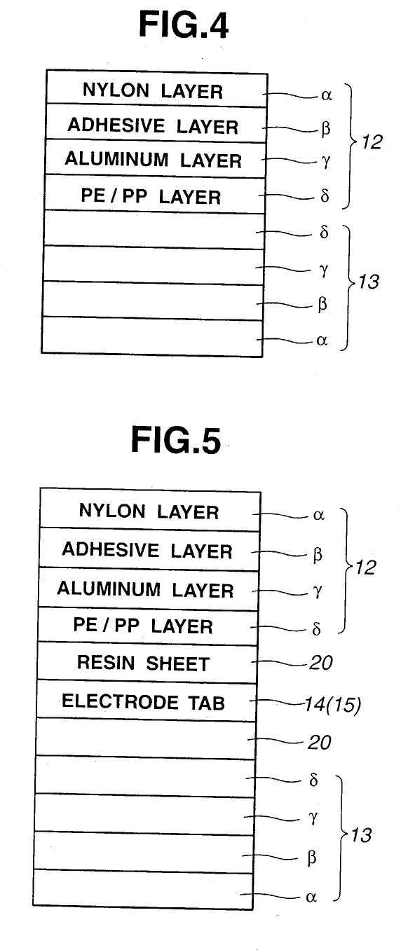

Each of laminate films 12, 13 is constituted of a nylon layer a as a synthetic resin layer, an adhesive layer β, an aluminum foil layer γ as a metal layer, a PE (polyethylene) or PP (polypropylene) layer δ as a synthetic resin layer in the order mentioned in the direction of from the outside to a joined surface (not identified) of the joining section B at which joined surface two laminate films 12, 13 are joined to each other, as shown in FIG. 4 which illustrates a cross-sectional layer structure of a section D of FIG. 1.

An example of the above battery 10 is a lithium ion rechargeable (secondary) battery. In this case, each anode plate 11A contains, as an anode active material, lithium-nickel compound (or double) oxide, more specifically, a compound represented by a general formula LiNi₁₋ₓMxO₂ where 0.01≦x≦0.5; M is at least one of Fe, Co, Mn, Cu, Zn, Al, Sn, B, Ga, Cr, V, Ti, Mg, Ca and Sr. Each anode plate 11A may contain the anode active material other than lithium-nickel double oxide, such as a lithium-manganese compound (or double) oxide represented by the general formula of LiyMn_{2-z}M′zO₄ where 0.9≦y≦1.2; 0.01≦z≦0.5; and M′ is at least one of Fe, Co, Ni, Cu, Zn, Al, Sn, B, Ga, Cr, V, Ti, Mg, Ca and Sr. The anode plate 11A may contain, as the anode active material, lithium-cobalt compound (or double) oxide represented by the general formula of LiCo₁₋ₓMxO₂ where 0.01≦x≦0.5; and M is at least one of Fe, Ni, Mn, Cu, Zn, Al, Sn, B, Ga, Cr, V, Ti, Mg, Ca and Sr.

The lithium-nickel double oxide, the lithium-manganese double oxide or the lithium-cobalt double oxide is produced by mixing carbonate of lithium and carbonate of nickel, manganese or cobalt as starting material in accordance with a required composition so as to form a mixture, and calcining the mixture at a temperature ranging from 600 to 1000° C. in an atmosphere containing oxygen. The starting materials are not limited to carbonate, and therefore hydroxide, oxide, nitrate, organic acid salt and/or the like may be used as the starting materials.

The anode active material such as lithium-nickel double oxide or the lithium-manganese double oxide preferably has an average particle size or diameter of 30 μm or smaller.

A cathode active material forming cathode plate 11B preferably has a specific surface area ranging from 0.05 to 2 m²/g, thereby sufficiently suppressing formation of SEI (Solid Electrolyte Interface) at the surface of cathode plate 11B. If the specific surface area of the cathode active material is smaller than 0.05 m²/g, a site where lithium can enter or be released from is too small, and therefore lithium doped into the cathode active material during charging cannot be sufficiently undoped from the cathode active material during discharging thereby lowering the charging and discharging efficiency. If the specific surface area of the cathode active material exceeds 2 m²/g, formation of SEI at the surface of cathode plate 11B cannot be controlled.

As the cathode active material, any material which can be doped or undoped with lithium in a condition where an electric potential to lithium is 2.0 V or lower can be used. Examples of such material to be used as the cathode active material are non-graphitizable carbon material, artificial graphite, natural graphite, pyrolytic graphite, cokes such as pitch coke, needle coke, petroleum coke and the like, and carbon-based materials such as graphite, glassy carbons, organic polymer compound fired body which is prepared by firing and carbonizing phenol resin or furan resin at a suitable temperature, carbon fiber, activated carbon and carbon black.

Additionally, metal which is able to form an alloy with lithium, alloy of the metal and compound of the metal may be used as the cathode active material. Examples of the metal, the alloy and the compound are oxide and nitride of the metal, such as iron oxide, ruthenium oxide, molybdenum oxide, tungsten oxide, tin oxide and the like, and nitride of iron, ruthenium, molybdenum, tungsten, tin and the like. The above oxide and the nitride can be doped and undoped with lithium at a relatively low electrical potential. The examples may include the typical elements in the group 3B of the periodic table of elements, elements such as Si and Sn, and alloys of Si and Sn represented by the general formula of MxSi an MxSn where M is at least one metal element other than Si and Sn. Using Si or Si alloy of the above examples as the cathode active material is particularly preferable.

As the electrolysis solution, a liquid solution which is prepared by dissolving an electrolyte salt in a nonaqueous solvent is used. Additionally, a polymer gel electrolyte which is prepared by causing an electrolyte solution to be retained in a polymer matrix may be used for the electrolysis solution, in which the electrolyte solution is prepared by dissolving an electrolyte in nonaqueous solvent. In case of using the polymer gel electrolyte, polyvinylidene fluoride, polyacrylonitrile or the like is used as the polymer material of the polymer matrix.

As the nonaqueous solvent, any nonaqueous solvent which has been used for nonaqueous electrolyte rechargeable (secondary) batteries of the type similar to the battery of the present invention can be used. Examples of such nonaqueous solvent are propylene carbonate, ethylene carbonate, 1,2-dimethoxyethane, diethyl carbonate, dimethyl carbonate, γ-butyrolactone, tetrahydrofuran, 1,3-dioxolane, 4-methyl-1,3-dioxolane, diethylether, sulfolane, methylsulfolane, acetonitrile, propionitrile, and the like. The above-listed nonaqueous solvents may be used singly or in combination upon mixing of plural nonaqueous solvents.

The nonaqueous solvent preferably contains unsaturated carbonate such as vinylene carbonate, ethyleneethylidene carbonate, ethyleneisopropylidene carbonate, propylidene carbonate, and/or the like. Of these unsaturated carbonates, vinylene carbonate is the most preferable to be contained in the nonaqueous solvent. The fact that the nonaqueous solvent contains the unsaturated carbonate leads to obtaining effects due to the property (the function of a protective film) of SEI formed at the cathode active material thereby further improving an over-discharge resistance characteristics of the battery.

The nonaqueous solvent contains the unsaturated carbonate preferably in an amount ranging from 0.05 to 5% by weight, more preferably in an amount ranging from 0.5 to 3% by weight. With the unsaturated carbonate in the above range, the rechargeable battery using the nonaqueous electrolysis solution can exhibit a high initial service capacity and a high energy density.

The electrolyte salt is not limited to particular ones as far as it is a lithium salt which exhibits ion conduction. Examples of the lithium salt serving as the electrolyte salt are LiClO₄, LiAsF₆, LiPF₆, LiBF₄, LiB(C₆H₅)₄, LiCl, LiBr, CH₃SO₃Li, CF₃SO₃Li, and the like. The above-listed lithium salts may be used singly or in combination upon mixing of a plurality of the lithium salts.

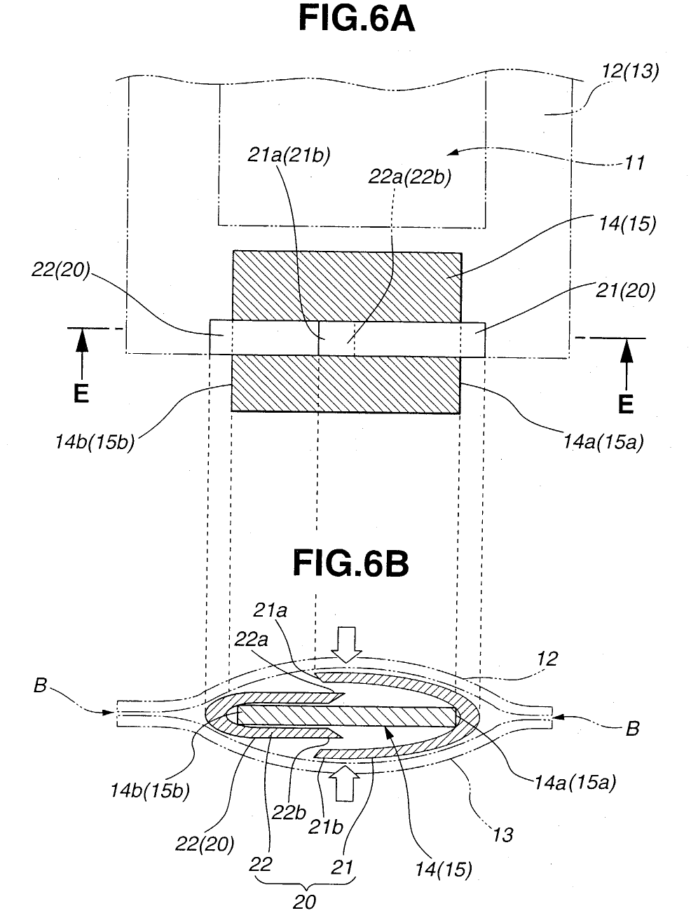

FIG. 6A and 6B illustrate anode tab 14 (cathode tab 15) in detail, in which FIG. 6A is a plan view of anode tab 14 (cathode tab 15) while FIG. 6B is a cross-sectional view taken in the direction of the arrows substantially along the line E-E of FIG. 6A. A generally annularly arranged or band-shaped resin (synthetic resin) sheet 20 is disposed surrounding anode tab 14 (cathode tab 15) in such a manner to cover a band-shaped section of anode tab 14 (cathode tab 15) which band-shaped section is located generally at the middle of the anode tab (cathode tab) in the lateral direction and extends vertically in FIG. 1 and in the vertical direction in FIG. 6A and extends laterally in FIG. 6A. As shown, resin sheet 20 covers opposite side end sections 14a, 14b (15a, 15b) of anode tab 14 (cathode tab 15) which opposite side end sections are laterally opposite in FIGS. 6A and 6B. Under the above state, annular band-shaped resin sheet 20 surrounding anode tab 14 (cathode tab 15) is put between the peripheral sections of laminate films 12, 13 and will be subjected to thermal welding.

In this state, a part (corresponding to the section F in FIG. 1) in which anode tab 14 (cathode tab 15) is put between the peripheral sections of laminate films 12, 13 takes a cross-sectional layer structure as shown in FIG. 5 in which anode or electrode tab 14 (cathode or electrode tab 15) is put between two layers of resin sheet 20 to form a three-layer structure which is put between two laminate films 12, 13. Thus, one layer of resin sheet 20 is in contact with laminate film 12 while the other layer of resin sheet 20 is in contact with laminate film 13.

Resin sheet 20 is formed of a material which is able to be welded to anode tab 14 (cathode tab 15) under heating, such as PE (polyethylene) or PP (polypropylene) which is used in this embodiment. Resin sheet 20 includes two separate sheets (or segmental resin sheets) 21, 22 which respectively cover the opposite side end sections 14a, 14b (15a, 15b) of anode tab 14 (cathode tab 15). Each separate sheet 21, 22 is generally C-shaped in cross-section, as shown in FIG. 6B. In a state where two separate sheets 21, 22 respectively cover the opposite end section 14a, 14b (15a, 15b), one longitudinal end sections 21a, 22a of separate sheets 21, 22 lie one upon another and are in contact with each other, and the other longitudinal end sections 21b, 22b of separate sheets 21, 22 line one upon another and are in contact with each other.

When resin sheet 20 is thermally welded to anode tab 14 (cathode tab 15) in the state where anode tab 14 (cathode tab 15) is covered with resin sheet 20, anode tab 14 (cathode tab 15) has been previously heated at a heating temperature which is around or relates to the glass transition temperature of the resin material forming resin sheet 20.

Sealing method and effects of the above battery of the first embodiment will be discussed.

When thermal welding is made on the joining section B upon putting anode tab 14 (cathode tab 15) between the peripheral sections of laminate films 12, 13, separate sheets 21, 22 are also heated under heating to the joining section B since side end sections 14a, 14b (15a, 15b) of anode tab 14 (cathode tab 15) have been already covered respectively with separate sheets 21, 22.

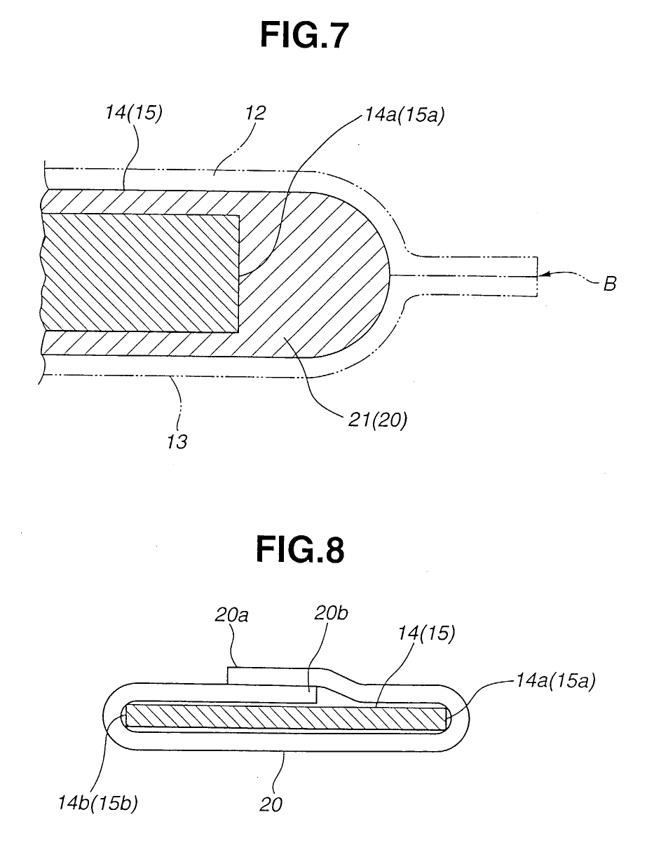

Accordingly, heated separate sheets 21, 22 are softened and thermally welded to anode tab 14 (cathode tab 15) following up the outer shapes of the opposite side end sections 14a, 14b (15a, 15b) of anode tab 14 (cathode tab 15) so as to maintain a tight contact condition between anode tab 14 (cathode tab 15) and separate sheets 21, 22 as shown in FIG. 7 in which a section around side end section 14a (15a) of anode tab 14 (cathode tab 15) is illustrated in an enlarged size. Also between separate sheet 21, 22 and the joining section B of laminate films 12, 13, separate sheet 21, 22 is welded to the resin layer 8 (shown in FIG. 5) forming the inner surface of the laminate film 12 (13) to maintain a tight contact condition between them under the effect of high shape follow-up ability of separate sheet 21, 22.

As appreciated from the above, according to the first embodiment of the battery, separate sheet 21, 22 is fully filled between the side end section 14a, 14b (15a, 15b) of anode tab 14 (cathode tab 15) and the joining section B of laminate films 12, 13, leaving no space therebetween, thereby providing a tight seal condition between the side end section of anode or cathode tab and the joining section B of the laminate films. This improves a sealing ability of the battery thereby preventing leak of the electrolysis solution from the battery.

Such an improvement in sealing ability of the battery can be achieved by a simple structure in which the opposite side end sections 14a, 14b (15a, 15b) of anode tab 14 (cathode tab 15) are covered with resin sheet 20. Thus, it is unnecessary to apply a complicated machining or working to each of anode and cathode tabs 14, 15, thereby avoiding lowering in production efficiency and cost-up of the battery.

In the first embodiment, one longitudinal-end sections 21a, 22a of separate sheets 21, 22 lie one upon another and are in contact with each other, and the other longitudinal end sections 21b, 22b of separate sheets 21, 22 line one upon another and are in contact with each other. As a result, two separate sheets 21, 22 (or resin sheet 20) are put into a condition to surround the whole periphery of each of anode and cathode tabs 14, 15, thus improving the sealing ability around each of anode and cathode tabs 14, 15. Additionally, the side end sections of the separate sheets 21, 22 are tightly contacted with each other, and therefore the separate sheets can be prevented from separating from each of anode and cathode tabs 14, 15 before carrying out the thermal welding, thereby improving a handling-readiness during setting the battery (in an unfinished state) on a thermal welding apparatus before carrying out the thermal welding.

Since resin sheet 20 (21, 22) is installed to each of anode tab 14 and cathode tab 15 which have been previously heated, the fluidity of resin sheet 20 can be increased during the thermal welding, thereby improving the adhesiveness of resin sheet 20 to the opposite side end sections 14a, 14b; 15a, 15b of anode and cathode tabs 14, 15. Particularly by setting the temperature for previously heating anode and cathode tabs 14, 15 as discussed above, at the temperature around the glass transition temperature of the resin material of resin sheet 20, the fluidity of resin sheet 20 can be further increased thereby further improving the adhesiveness of resin sheet 20 to the opposite side end sections 14a, 14b; 15a, 15b of anode and cathode tabs 14, 15.

By installing resin sheet 20 to each of anode tab 14 and cathode tab 15 which have been previously heated, resin sheet 20 is brought into a condition in which its surface portion contacting to each of anode and cathode tabs 14, 15 melts and adheres to the surface of each of the anode and cathode tabs, and therefore resin sheet 20 (separate sheets 21, 22) can be prevented from readily separating from each of anode and cathode tabs 14, 15 before carrying out the thermal welding, thereby improving a handling-readiness during setting the battery (in an unfinished state) on the thermal welding apparatus before carrying out the thermal welding.

FIG. 8 illustrates an essential part of a second embodiment of the battery according to the present invention, which is similar to the first embodiment. FIG. 8 is a cross-sectional view showing a state where resin sheet 20 is wound around anode tab 14 (cathode tab 15). In this embodiment, resin sheet 20 is constituted of a single band-shaped resin (synthetic resin) sheet which is formed of the same material as that of resin sheet 20 of the first embodiment. This single band-shaped resin sheet 20 has such a length as to sufficiently cover the opposite side end sections 14a,14b (15a, 15b) of anode tab 14 (cathode tab 15), and is wound around anode tab 14 (cathode tab 15) in such a manner as to pass on or cover the opposite side end sections 14a, 14b (15a, 15b) of anode tab 14 (cathode tab 15). Additionally, also in this embodiment, longitudinal opposite end sections 20a, 20b of resin sheet 20 lie one upon another and are in contact with each other.

In the second embodiment, each of anode and cathode tab 14, 15 is wound by single band-shaped resin sheet 20, and therefore positioning for resin sheet 20 can be easily and securely accomplished when opposite side end sections 14a, 14b (15a, 15b) of anode tab 14 (cathode tab 15) are covered with resin sheet 20. Under a condition where longitudinal opposite end section 20a, 20b of resin sheet 20 lie one upon another and are in contact with each other, sealing ability around each of anode and cathode tab 14, 15 can be effectively improved like in the first embodiment. In the second embodiment, it is preferable to previously heating each of anode and cathode tabs 14, 15 before resin sheet 20 is wound around each of the anode and cathode tab 14, 15.

While the invention has been particularly shown and described with reference to preferred embodiments thereof, it will be understood that the invention is not limited to the embodiments, and therefore a variety of changes in form and details may be made therein without departing from the spirit and scope of the invention. For example, the present invention may be applied not only to lithium ion rechargeable batteries but also to other batteries having arrangements similar to the lithium ion rechargeable batteries.

As appreciated from the above, according to the present invention, the resin sheet can be welded to each of the anode and cathode tabs. This resin sheet is brought into a condition to cover the opposite side end sections of each of the anode and cathode tabs, under which the resin sheet is put between the peripheral sections of the laminate films to be subjected to the thermal welding. Under this condition, heat during the thermal welding is applied to the resin sheet so that the resin sheet is welded to the opposite side end sections of each of the anode and cathode tabs. As a result, a space between one side end section of each of the anode and cathode tabs and the joining section of the laminate films and another space between the other side end section of each of the anode and cathode tabs and the joining section of the laminate films are fully filled with the softened resin of the resin sheet thereby putting the opposite side end sections of each of the anode and cathode tabs and the joining section of the laminate films into a tight seal condition without forming any clearance. This largely improves the sealing ability of the battery. It will be appreciated that the improvement in the sealing ability of the battery can be achieved by such a simple structure as to cover the opposite side end sections of each of the anode and cathode tabs with the resin sheet. Thus, it is unnecessary to apply complicated machining or working to each of the anode and cathode tabs, thereby avoiding lowering in production efficiency and increasing in production cost of the product or battery.

The entire contents of Japanese Patent Application P2002-184532 (filed Jun. 25, 2002) are incorporated herein by reference.

Although the invention has been described above by reference to certain embodiments of the invention, the invention is not limited to the embodiments described above. Modifications and variations of the embodiments described above will occur to those skilled in the art, in light of the above teachings. The scope of the invention is defined with reference to the following claims.

What is claimed is:

1. A sealing method for a battery which includes a power generating element including an anode plate, a cathode plate and a separator disposed between the anode plate and the cathode plate, first and second laminate films between which the power generating element is disposed, each of the first and second laminate films including a metal layer and a synthetic resin layer, the first and second laminate films having respectively first and second peripheral sections which are to be joined with each other by thermal welding so as to form a peripheral joining section so that the first and second laminate films serve as a container inside which the power generating element is sealingly disposed, and anode and cathode tabs which are respectively connected to the anode and cathode plates, the anode and cathode tabs being drawn out of the container through the joining section of the laminate films,
the sealing method comprising:
providing first and second resin sheets respectively around first and second sites where the anode and cathode tabs are respectively located, to be positioned between the first and second peripheral sections of the first and second laminate sheets;
covering opposite side end sections of the anode tab with the first resin sheet and covering opposite side end sections of the cathode tab with the second resin sheet; and
thermally welding the first and second resin sheets in a condition where each resin sheet is put between the first and second peripheral sections of the first and second laminate films after covering the opposite side end sections of the anode and cathode tab respectively with the first and second resin sheets.

2. A sealing method as claimed in claim 1, wherein each of the first and second resin sheets includes first and second segmental resin sheets which are separable from each other, the first segmental resin sheet covering the opposite side end sections of the anode tab, the second segmental resin sheet covering the opposite side end sections of the cathode tab.

3. A sealing method as claimed in claim 2, wherein the first segmental resin sheet has first and second end sections, and the second segmental resin sheet has third and fourth end sections, the first and third end sections lying one upon another and being in contact with each other, the second and fourth end sections lying one upon another and being in contact with each other.

4. A sealing method as claimed in claim 1, wherein each of the first and second resin sheets is a single resin sheet for covering the opposite side end sections of each of the anode and cathode tabs.

5. A sealing method as claimed in claim 4, wherein each of the first and second resin sheets has opposite end sections which lie one upon another and are in contact with each other.

6. A sealing method as claimed in claim 1, where each of the anode and cathode tabs is heated before thermally welding the first and second resin sheets.

7. A sealing method as claimed in claim 4, wherein each of the anode and cathode tabs is heated at a temperature relating to a glass transition temperature of each of the first and second resin sheets.

8. A sealing method as claimed in claim 1, wherein the first resin sheet covers at least a band-shaped section of the anode tab including a part of each of the opposite side end sections, and the second resin sheet covers at least a band-shaped section of the cathode tab including a part of each of the opposite side end sections.

9. A battery comprising:
a power generating element including an anode plate, a cathode plate, and a separator disposed between the anode plate and the cathode plate;
first and second laminate films between which the power generating element is disposed, each of the first and second laminate films including a metal layer and a synthetic resin layer, the first and second laminate films having respectively first and second peripheral sections which are to be joined with each other by thermal welding so as to form a peripheral joining section so that the first and second laminate films serve as a container inside which the power generating element is sealingly disposed; and
anode and cathode tabs which are respectively connected to the anode and cathode plates, the anode and cathode tabs being drawn out of the container through the joining section of the laminate films; and
first and second resin sheets disposed respectively around first and second sides where the anode and cathode tabs are respectively located, to be positioned between the first and second peripheral sections of the first and second laminate sheets, the first resin sheet covering opposite side end sections of the anode tab, the second resin sheet covering opposite side end sections of the cathode tab, the first and second resin sheets being welded respectively to the anode and cathode tabs.

10. A battery as claimed in claim 9, wherein each of the first and second resin sheets includes first and second segmental resin sheets which are separable from each other, the first segmental resin sheet covering the opposite side end sections of the anode tab, the second segmental resin sheet covering the opposite side end sections of the cathode tab.

11. A battery as claimed in claim 10, wherein the first segmental resin sheet has first and second end sections, and the second segmental resin sheet has third and fourth end sections, the first and third end sections lying one upon another and being in contact with each other, the second and fourth end sections lying one upon another and being in contact with each other.

12. A battery as claimed in claim 9, wherein each of the first and second resin sheets is a single resin sheet for covering the opposite side end sections of each of the anode and cathode tabs.

13. A battery as claimed in claim 12, wherein each of the first and second resin sheets has opposite end sections which lie one upon another and are in contact with each other.
